(19) United States
(12) Patent Application Publication
(10) Pub. No.: US 2014/0244416 A1
(43) Pub. Date: Aug. 28, 2014

(54) METHOD AND SYSTEM TO FACILITATE THE ADDITION OF ITEMS TO AN ELECTRONIC ITEM CATALOG

(71) Applicant: WAL-MART STORES, INC., Bentonville, AR (US)

(72) Inventors: Rajkumar Venkat, Fremont, CA (US); Chris Undernehr, Bentonville, AR (US)

(73) Assignee: Wal-Mart Stores, Inc., Bentonville, AR (US)

(21) Appl. No.: 13/781,398

(22) Filed: Feb. 28, 2013

(51) Int. Cl. G06Q 30/06

(52) U.S. Cl. CPC G06Q 30/0603
USPC 705/26.1

(57) ABSTRACT

Techniques for allowing a vendor to provide item information for an item to be sold through an online or a brick and mortar store are disclosed. The techniques include receiving first item information from a vendor relating to an item which is to be included in an electronic item catalog for sale through the store. The techniques also include providing a customized spreadsheet which is customized for the item according to the first item information to the vendor via spreadsheet software and receiving second item information into the customized spreadsheet from the vendor. The techniques include validating the second item information and publishing the second item information to an item catalog server for inclusion in the electronic item catalog.

### BACKGROUND INFORMATION

1. Field of the Disclosure

The present invention relates to managing items in an electronic item catalog. In particular, examples of the present invention relate to an approach for facilitating vendor management of items in an electronic catalog.

2. Background

Many stores sell a considerable number of items. Modern supermarkets or super centers sell a significant variety of items, including groceries, home goods, automotive goods, sporting goods, etc. Additionally, many of these companies also maintain an online retail environment. Customers may often purchase both items sold in a retail location as well as a large number of items which are only sold in the online store or marketplace. As stores provide an increasing number of products to customers, it becomes more important that the electronic item catalogs used to manage the sale of these items is both detailed and consistent. Simultaneously, it becomes increasingly more difficult to manage the item catalog and ensure consistency between the large numbers of items.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a schematic illustrating various aspects of a store according to the present disclosure.

FIG. 2 is a schematic illustrating the store of FIG. 1 in context of vendors and customers.

FIG. 3 is a schematic illustrating a POS system used in accordance with some aspects of the present disclosure.

FIG. 4 is a schematic illustrating a POS system used in accordance with some aspects of the present disclosure.

FIG. 5 is a schematic illustrating data transfer between a computer and an item catalog server in accordance with some aspects of the present disclosure.

FIGS. 6 through 15 are spreadsheets illustrating entry of item data for inclusion in an item catalog.

FIG. 16 is a flow chart illustrating an example of item data entry for inclusion of the item in an item catalog.

FIG. 17 is a schematic illustrating example components of a computer.

FIG. 18 is a schematic illustrating example components of a server.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment”, “an embodiment”, “one example” or “an example” means that a particular feature, structure or characteristic described in connection with the embodiment or example is included in at least one embodiment of the present invention. Thus, appearances of the phrases “in one embodiment”, “in an embodiment”, “one example” or “an example” in various places throughout this specification are not necessarily all referring to the same embodiment or example. Furthermore, the particular features, structures or characteristics may be combined in any suitable combinations and/or sub-combinations in one or more embodiments or examples. . In addition, it is appreciated that the figures provided herewith are for explanation purposes to persons ordinarily skilled in the art and that the drawings are not necessarily drawn to scale.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present invention may be written in any combination of one or more programming languages.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

The flowchart and block diagrams in the flow diagrams illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The disclosure particularly describes how vendors selling items to/through a store may manage their items through a native spreadsheet user interface. Particularly, the present disclosure describes how a software plug-in may allow a vendor to manage data within a spreadsheet environment and may interface with a product catalog server via the spreadsheet user interface.

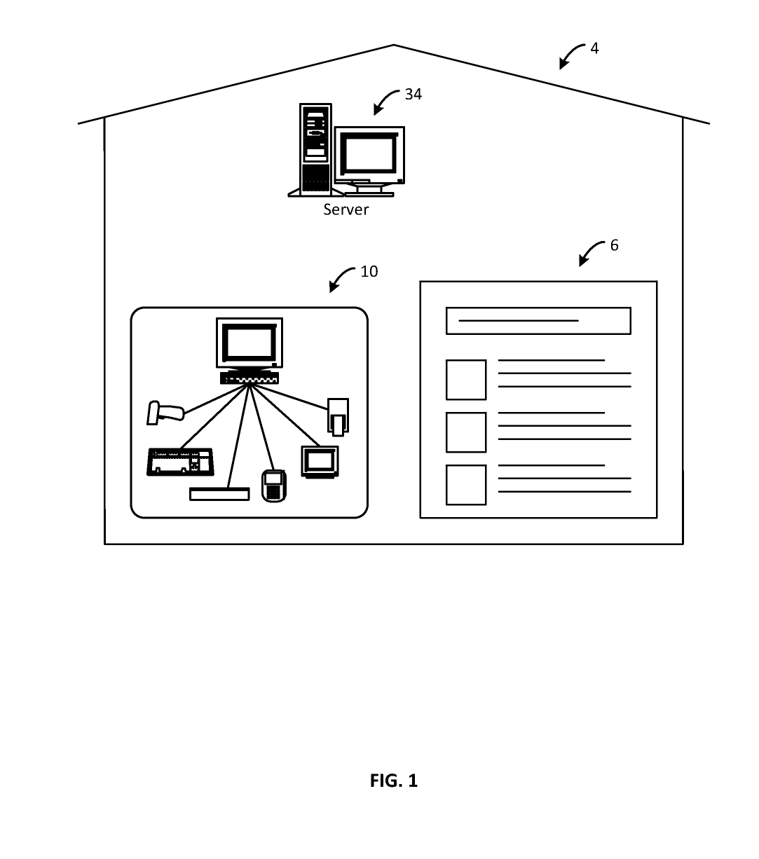

Referring to FIG. 1, a customer may shop at a store 4. The store 4 is representative of a larger corporate environment which may provide many avenues of interface with a customer as well as with vendors. In a modern shopping environment, a store 4 may include both a brick and mortar retail location, represented by a point of sale (POS) system 10 and an on line retail location represented by a webpage hosting an internet store 6. Additionally, the store 4 may include a server 34 as well as other supporting systems to manage and support sales at the brick and mortar store location(s) as well as sales through the internet store 6.

A customer who is interacting with the store may frequently interact with both the brick and mortar retail store as well as with the internet store 6. In these interactions, a customer will typically desire a measure of consistency. For example, a customer may desire to look on the internet store for items sold at the brick and mortar store before entering the brick and mortar store to purchase the item. It is appreciated that it is desirable to provide consistency to a customer.

Additionally, it is desirable to provide consistency to reduce the demands of a server 34 (i.e. an item catalog server 34) by providing consistency between retail and online locations. Moreover, it is desirable to reduce the workload associated with management of an item catalog server 34. In particular, it is desirable to reduce the workload associated with entering items into an electronic item catalog and with updating or managing items in the electronic catalog.

A vendor providing goods to the store 4 may use a software plug-in to provide information directly to the item catalog server 34. The software plug-in may provide an interface between the vendor and the item catalog server 34 which allows a degree of access to the vendor while preventing the vendor from taking undesirable actions. The software plug-in may allow the vendor to upload item information to the item catalog server. In this manner, the software plug-in may significantly reduce the store workload associated with maintaining the electronic item catalog stored on the item catalog server 34.

The software plug-in may allow the vendor to work within a known software package to prepare item information and upload item information to the item catalog server 34 in a convenient manner. In particularly, the software package may allow the vendor to work within spreadsheet software such as MICROSOFT EXCEL®. This reduces errors and streamlines the process for the vendor. Additionally, the software plug-in provides a structured interface which guides the vendor in providing necessary data types as well as valid data values for an item. The software plug-in also allows a great deal of flexibility to the vendor in providing additional data as is desired to adequately describe the item.

The software plug-in may interface between the vendor and the item catalog server 34, allowing the vendor to validate data entry and upload completed item data to the item catalog server 34 from within the spreadsheet software. The software plug-in eliminates a traditional file upload or transfer between the vendor and the item catalog server 34 and reduces the errors frequently associated with interaction and data transfer between a person and an unfamiliar data server. The software plug-in also allows a vendor to save processed data locally, allowing the future reference and use of the date created while preparing item information for the item catalog server 34. The software plug-in may also allow a vendor to search for information on the item catalog server 34 and the software plug-in may download the search information into a spreadsheet for use by the vendor.

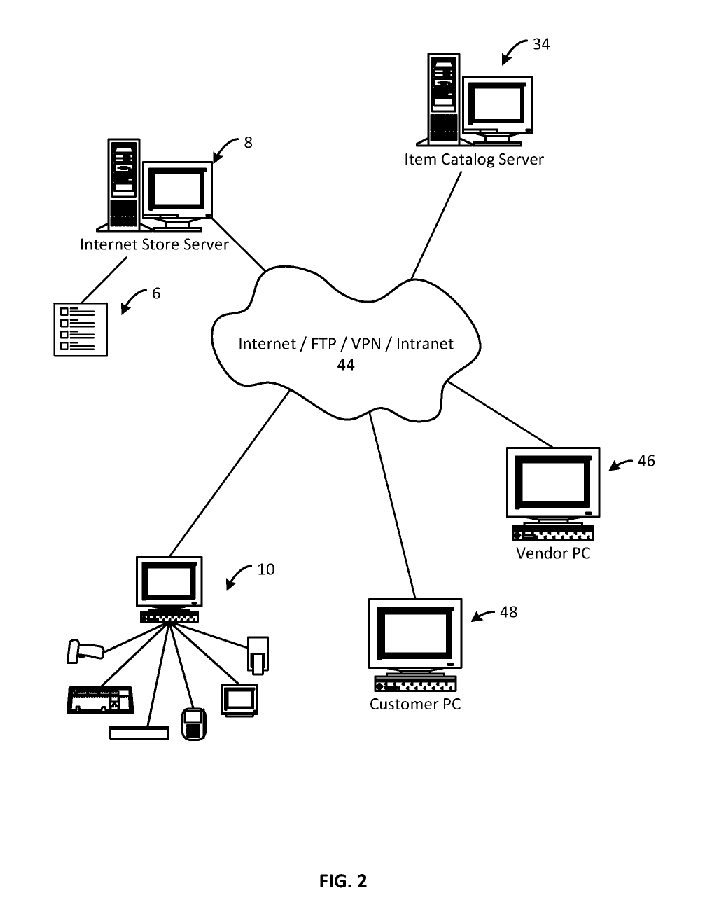

Referring to FIG. 2, in selected embodiments, the software, hardware, and associated components of a store computer system may be programmed and configured to implement one or more embodiments described herein. A vendor may communicate with an item catalog server 34 via a computer 46 and a network connection or internet connection 44 to provide item information to the item catalog server 34. Particularly, the vendor may use a software plug-in which allows the vendor to work within a spreadsheet program to edit, organize, and validate item data and thereafter transmit the item data to the item catalog server 34.

The item catalog server 34 may communicate with a POS system 10 at a brick and mortar store retail location such as through a network connection or the internet 44. By way of example, the item catalog server 34 may provide item information to the store location such as UPC and price information to facilitate sales of items. The item catalog server 34 may provide item description information to the store location to facilitate understanding of the item and to facilitate customer service.

The item catalog server 34 may also communicate with an internet store server 8 which hosts the webpage to provide an internet store 6 to customers. The item catalog server 34 may provide item information to the internet store server 8 so that this information may be presented to a customer and used to complete internet purchase transactions. A customer, via a computer 48, may transmit information and receive information from the internet store 6 as part of a purchasing process.

Various parts of a store computer system including a POS system and item catalog system may allow vendors to upload and manage item information and may allow customers to obtain item information and complete purchase transactions. Various parts and structures are described to illustrate how these may allow a store security associate to complete an audit of a purchase where a customer did not receive a paper receipt.

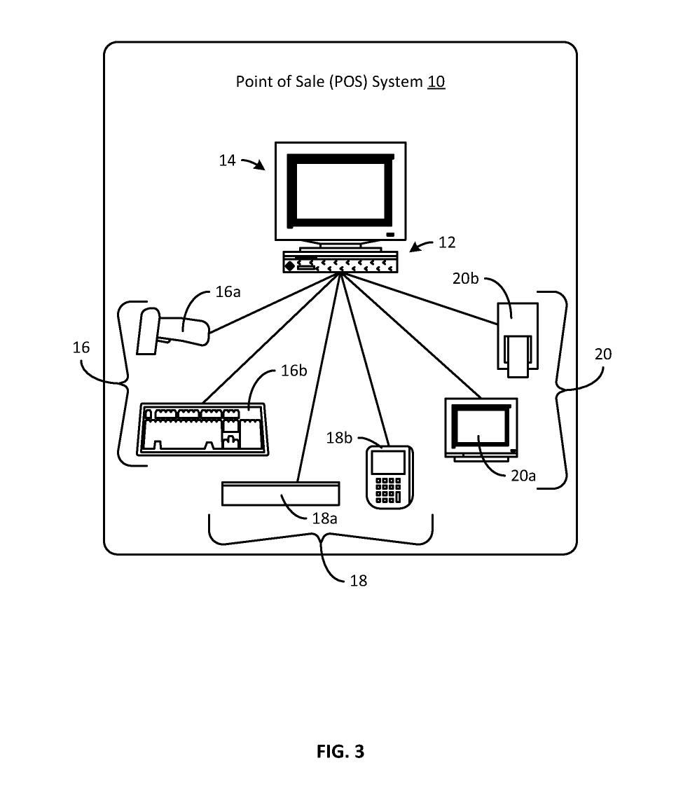

Referring to FIG. 3, in selected embodiments, the hardware, software, or hardware and software of a POS system 10 may be configured to receive and utilize item information as described herein. For example, a POS system 10 may be manufactured, programmed, modified, or upgraded to support communications with an item catalog server 34 and to thereby use item information from the item catalog server 34 to facilitate customer purchase of an item. It is appreciated that the POS system may involve one or more parts of a local POS terminal and associated computers or servers, remote computers or servers, and associated equipment.

A POS system 10 may include various components. In certain embodiments, a POS system 10 may include a central or primary computer 12, a monitor 14 (e.g., a cashier-facing monitor 14), one or more input devices 16 (e.g., scanners 16a, keyboards 16b, scales, or the like), one or more payment devices 18 (e.g., cash drawers 18a, card readers 18b) for receiving or returning payments, one or more output devices 20 (e.g., customer-facing display 20a or monitor 20a, receipt printer 20b), or the like or combinations or sub-combinations thereof.

A computer 12 may form the primary processing unit of a POS system 10. Other components 16, 18, 20 forming part of a POS system 10 may communicate with the computer 12. Input devices 16 and certain payment devices 18 may feed data and commands to a computer 12 for processing or implementation. For example, a scanner 16a may pass data communicating the identity of one or more items to be purchased, returned, or the like to a computer 12. Similarly, a card reader 18b may pass payment information to a computer 12.

Conversely, output devices 20 and certain payment devices 18 may follow or implement commands issued by a computer 12. For example, a cash drawer 18a may open in accordance with the commands of a computer 12. Similarly, a customer-facing display 20a and receipt printer 20b may display or output data or information as instructed by a computer 12.

In selected embodiments, in addition to handling consumer transactions (e.g., purchases, returns), a POS system 10 may also provide or support certain “back office” functionality. For example, a POS system 10 may provide or support communications with an item catalog server 34, inventory control, purchasing, receiving and transferring products, or the like. A POS system 10 may also store sales and customer information for reporting purposes, marketing purposes, receivables management, trend analysis, cost analysis, price analysis, profit analysis, or the like. If desired or necessary, a POS system 10 may include an accounting interface to pass certain information to one or more in-house or independent accounting applications. A POS system 10 may also communicate with third parties and may transmit receipt information and facilitate customer management of receipts.

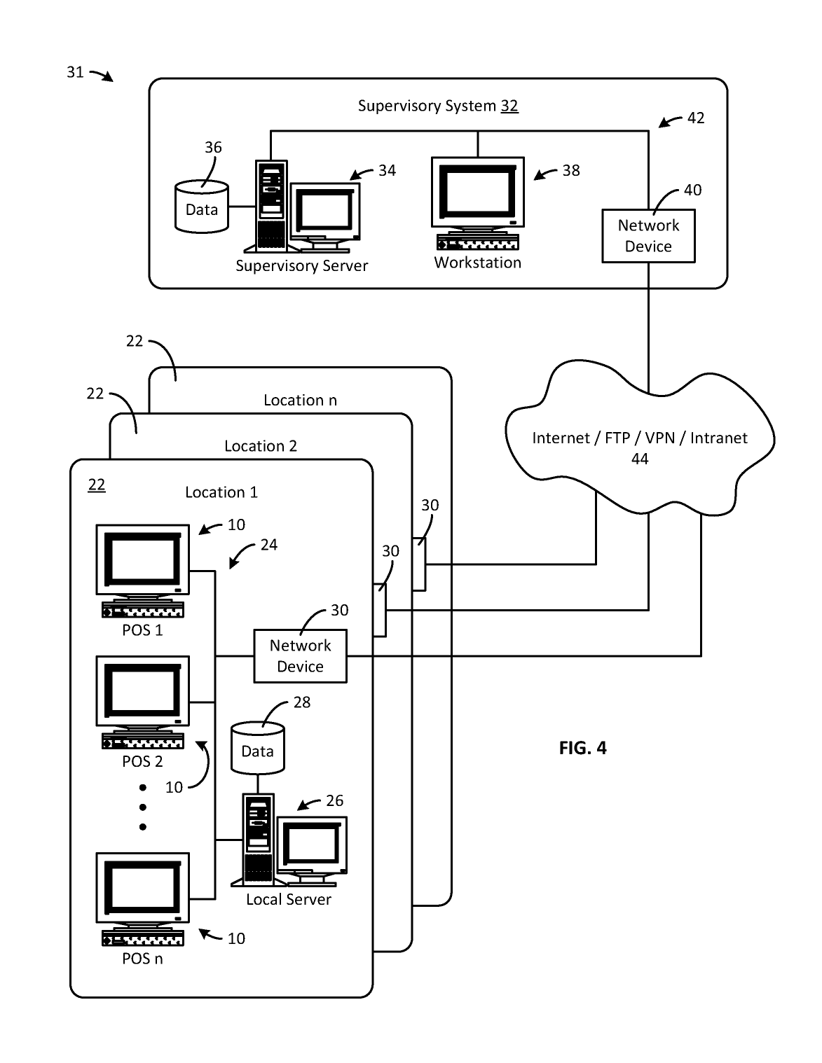

Referring to FIG. 4, in selected embodiments, a POS system 10 may operate substantially independently, as a stand-alone unit. Alternately, a POS system 10 may be one of several POS systems 10 forming the front line of a larger system. For example, multiple POS systems 10 may operate at a particular location 22 (e.g., within a brick-and-mortar store). In such embodiments, the various POS systems 10 may be interconnected via a LAN 24. A LAN 24 may also connect the POS systems 10 to a local server 26.

A local server 26 may support the operation of the associated POS systems 10. For example, a server 26 may receive item information from an item catalog server 34 and may provide a central repository from which certain data needed by the associated POS systems 10 may be stored, indexed, accessed, or the like. A server 26 may serve certain software to one or more POS systems 10. In certain embodiments, a POS system 10 may offload certain tasks, computations, verifications, or the like to a server 26.

Alternatively, or in addition thereto, a server 26 may support certain back office functionality. For example, a server 26 may receive and compile (e.g., within one or more associated databases 28) data from the various associated POS systems 10 to provide or support inventory control, purchasing, receiving and transferring products, or the like. A server 26 may also receive and compile sales and customer information for reporting purposes, marketing purposes, receivables management, trend analysis, cost analysis, price analysis, profit analysis, or the like.

In certain embodiments, one or more POS systems 10 or servers 26 corresponding to a particular store retail location 22 may communicate with or access one or more remote computers or resources via one or more network devices 30. For example, a network device 30 may enable a POS system 10 to contact outside resources and verify the payment credentials (e.g., credit card information) provided by a customer. A network device 30 may comprise a modem, router, or the like.

In selected embodiments, a POS system 10 may operate within an enterprise-wide system 31 comprising multiple locations 22 (e.g., branches 22 or stores 22). In such embodiments, each location 22 may have one or more POS systems 10, local servers 26, local databases 28, network devices 30, or the like or combinations or sub-combinations thereof connected by a computer network (e.g., a LAN 24). Additionally, each such location 22 may be configured to interact with one or more supervisory systems 32. For example, multiple branch locations 22 may report to an associated “headquarters” location or system 32.

A supervisory system 32 may comprise one or more supervisory servers 34, databases 36, workstations 38, network devices 40, or the like or combinations or sub-combinations thereof. The various components of a supervisory system 32 may be interconnected via a computer network (e.g., a LAN 42). In selected embodiments, a supervisory system 32 may comprise one or more item catalog servers 34 providing a central repository from which certain item data needed by the one or more POS systems 10 or local servers 26 may be stored, indexed, accessed, or the like.

An item catalog server 34 may receive and compile (e.g., within one or more associated databases 36) item data from various item vendors who provide items to the store 4 for sale. The item catalog server 34 may provide or support inventory control, purchasing, receiving and transferring products, or the like and may use the item information in this capacity.

A supervisory system 32 may be connected to one or more associated locations 22 or branches 22 in via any suitable computer network 44 (e.g., WAN 44). For example, in selected embodiments, one or more locations 22 may connect to a supervisor system 32 via the Internet. Communication over such a network 44 may follow any suitable protocol or security scheme. For example, communication may utilize the File Transfer Protocol (FTP), a virtual private network (VPN), intranet, or the like.

It is thus appreciated that in discussing the functionality of the various POS terminals and servers, the embodiments described herein may be implemented in a system contained within a single location or across multiple locations. By way of example, the functionality accomplished by a server or computer, such as storing, processing, and transmitting/ sending receipt information, may be accomplished by a local computer or a remote computer such as servers 26 and 34.

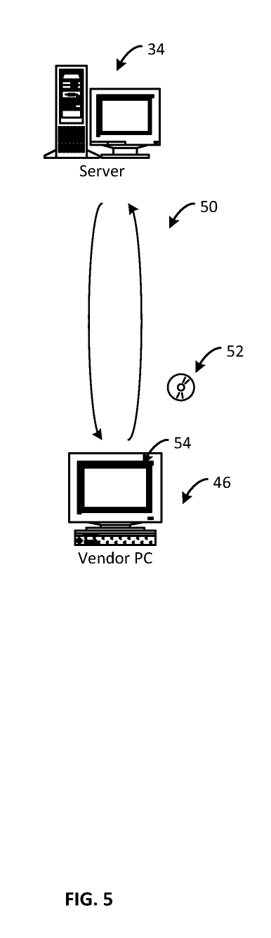

Referring to FIG. 5, a vendor may use a computer 46 to communicate with an item catalog server 34 as indicated at 50. The vendor may download or may already have downloaded item management software 52 to the computer 46. As indicated at 50, the vendor may transmit information to the item catalog server 34. The vendor may have created an account with the item catalog server 34 which created credentials that allow the vendor to interface with the item catalog server 34 and which may have been required to obtain the item management software 52. Particularly, the account may include contact information for the vendor, company information, and may include an authorization code other secure information to verify that the vendor has authority to create such an account. Such an account may provide login credentials for the vendor to facilitate communication between the item catalog server 34 and the vendor computer 46 in the process of receiving item information from the vendor.

The item catalog server 34 may likewise transmit information to the vendor computer 46. In particular, the item catalog server 34 may receive information from, process, and transmit information to the vendor computer 46 in the process of transmitting item information from the vendor computer 46 to the item catalog server 34.

The vendor may receive item management software 52 on the computer 46 which may enable them to manage their item information, provide new item information, etc. In particular, the item management software 52 may operate within a program 54 (illustrated by a program window 54 on computer 46). The item management software 52 may be a software plug-in (such as may be referred to as an add-on or a plug-in) that operates within existing software. In one example, the software plug-in 52 operates within a spreadsheet program such as MICROSOFT EXCEL® or another such spreadsheet program. In such a situation, the vendor may download the software plug-in 52 from the item catalog server 34, install the software plug-in 52 on the computer 46, and then proceed with item management as discussed herein.

The vendor may operate the software plug-in and access the additional functionality to prepare and transmit item information to the item catalog server 34 while using the spreadsheet software. This is advantageous as most people are familiar with such a spreadsheet program and the vendor does not need to learn a separate piece of software to manage item information within the electronic item catalog hosted by the item catalog server 34.

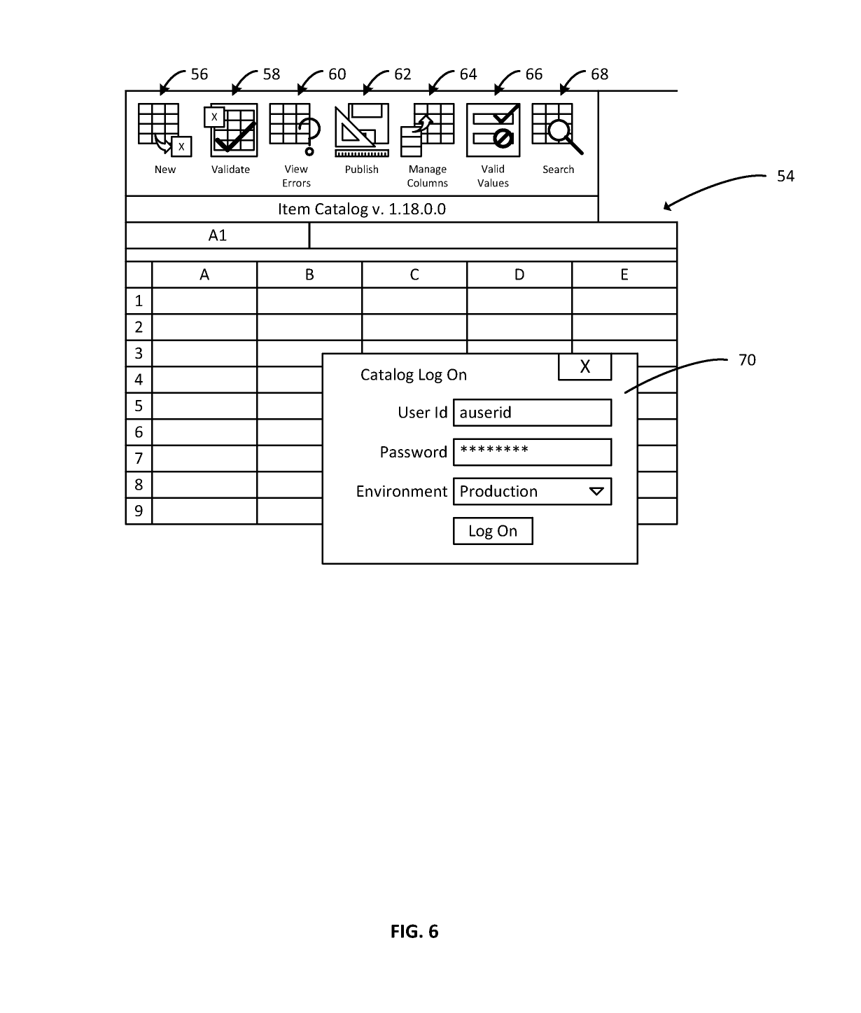

Referring now to FIG. 6, a vendor may operate a software application 54 on a computer 46 after installing a software plug-in 52. The software application 54 may be a spreadsheet program, such as MICROSOFT WINDOWS®. The software plug-in 52 operates within the spreadsheet software and provides additional functionality. Once the software plug-in 52 is installed, new buttons show up in the spreadsheet application to provide functionality to the vendor. As shown, the software plug-in 52 may provide a new button 56, a validate button 58, a view errors button 60, a publish button 62, a manage columns 64, a valid values button 66, and a search button 68. These buttons may be provided in a location such as a header or ribbon, a menu, a dropdown menu, etc. Any interaction with these buttons may initiate communication between the software plug-in 52 and the item catalog server 34. Interaction with the buttons may cause a security dialog to be displayed, such by displaying a pop up window 70 with a security dialog requiring that the vendor log in or otherwise provide security credentials. The security credentials may be passed to the item catalog server 34 and, if valid, a token may be saved by the vendor computer for future secure communication between the application and the server 34.

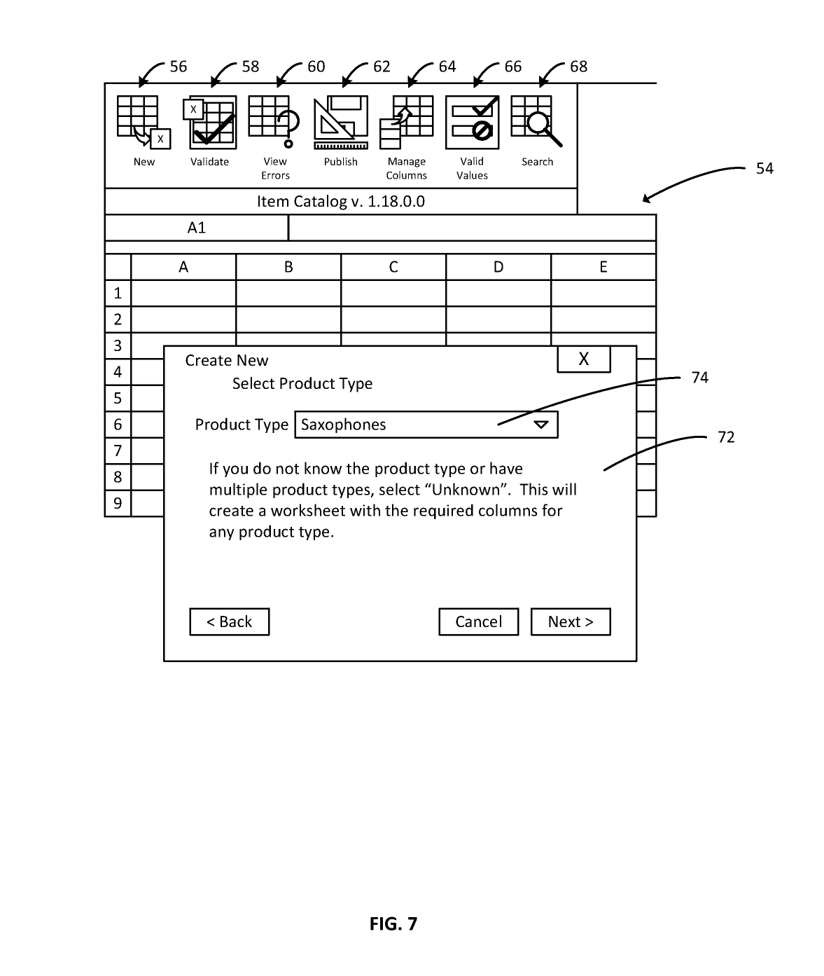

Referring now to FIG. 7, clicking the new button 56 may prompt the vendor to select what type of product will be created (i.e. the type of item to be added to the electronic catalog). The software plug-in 52 may open a window 72 that provides a drop down menu 74 or otherwise allows the vendor to select a product type. Based on the vendor's selection of a product type, the vendor may then choose what data fields they are going to provide values for. If the vendor selects a particular product type, the software plug-in 52 may limit the available data fields to only those relevant to the product type. If the vendor selects an unknown product type, all data fields may be available to the vendor.

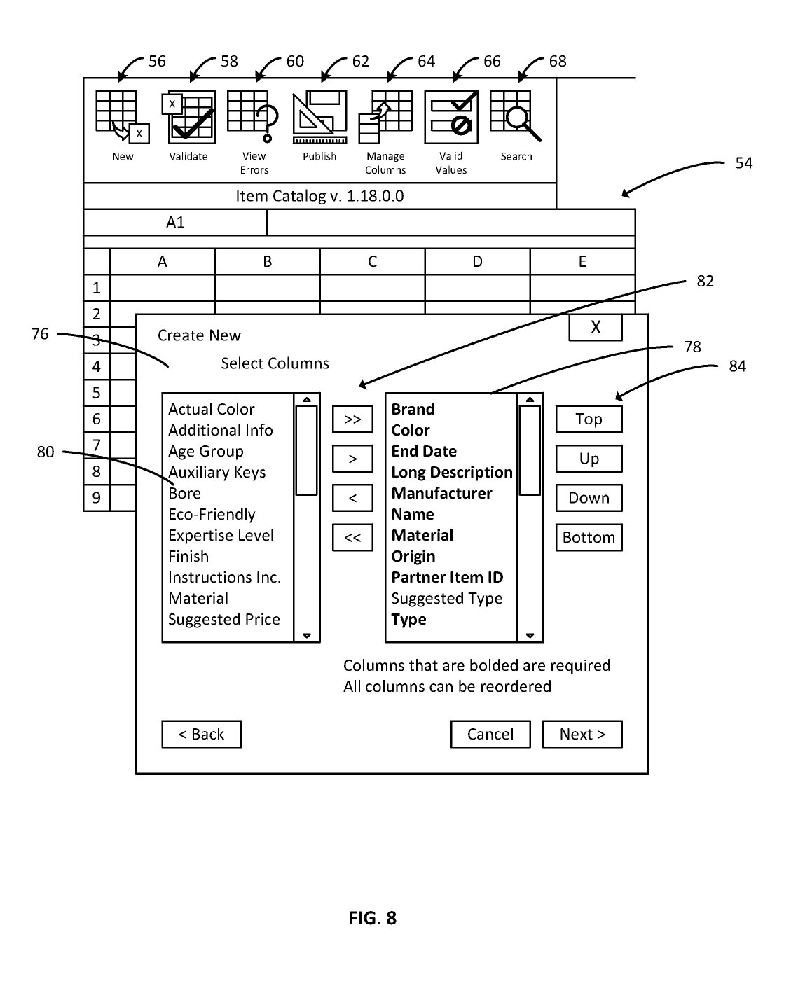

Referring now to FIG. 8, the software plug-in 52 may display a window 76 which allows the vendor to select which different data fields will be used to enter item information. As indicated, the software plug in 52 may present mandatory data fields 78 to the vendor and also allow the vendor to select from optional data fields 80 to provide additional product information. Both the mandatory data fields 78 and the optional data fields 80 may be specific to the selected item type if previously selected. In this manner, the software plug-in 52 may streamline the process of adding an item to the electronic item catalog by only making relevant data fields available to the vendor. The vendor may select all data fields, only necessary data fields, or additional desired data fields.

The software plug-in 52 may provide buttons 82 or other input features to allow a vendor to add or remove optional data fields 80 from the list of data fields which will be provided for the item. Optional data fields 80 which are selected by the user may be moved to a group of selected data fields which also contains the mandatory data fields 78. Additionally, the software plug-in 52 may provide buttons 84 or other input features to allow the vendor to change the order of the selected data fields. Changing the order of the selected data fields will change the order of the data fields in the created spreadsheet. The software plug-in 52 provides a high degree of flexibility to the vendor in selecting the desired data fields and in structuring the resultant spreadsheet in a manner most convenient to their items and the associated data.

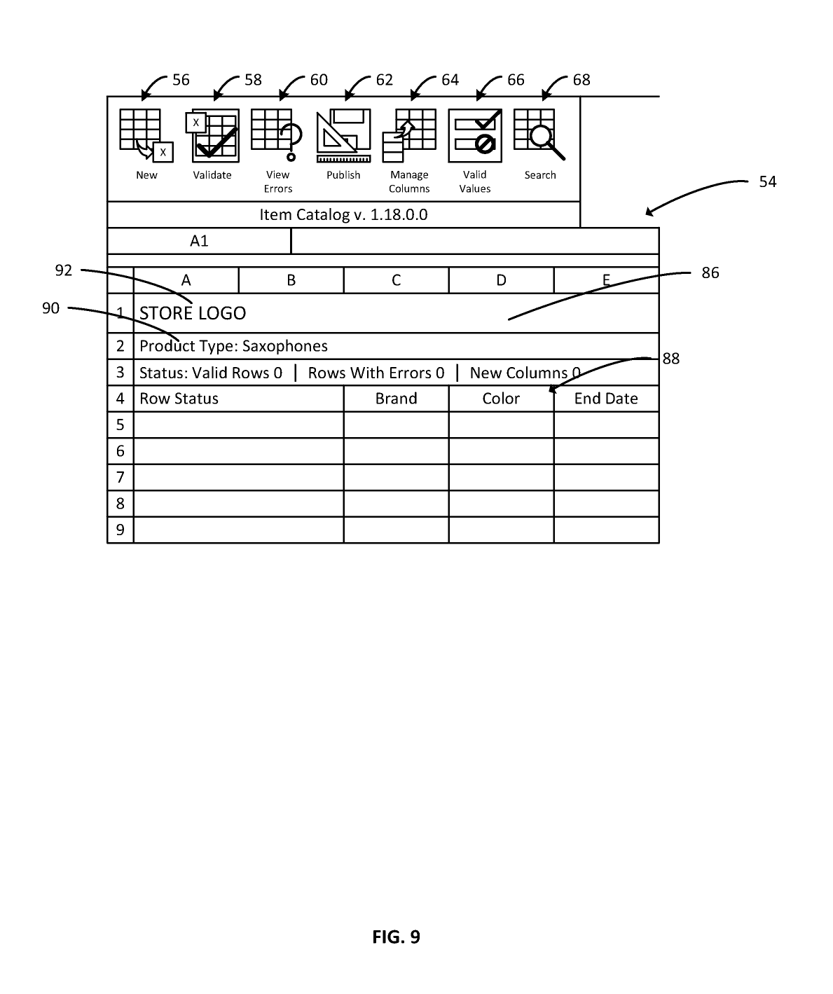

Referring now to FIG. 9, once the data field selections are made, a customized spreadsheet 86 is created within the spreadsheet software. The spreadsheet 86 is customized with the selected fields placed as column headers (indicated generally at 88) which are in the order selected by the vendor. The spreadsheet 86 may include a header 90 that displays the product type which was selected by the vendor, and may also include a logo 92 indicating the store with which the vendor is interacting and providing item data. The customized spreadsheet is pushed down from the item catalog server 34 to the vendor. The vendor may select the product type and the software plug-in 52 selects the necessary data fields and allows the vendor to select optional data fields. Since the spreadsheet is pushed down to the user during creation, validation, etc. the user will always have up to date information to work with. The vendor need not store any spreadsheet template or start with any type of file.

If data fields need to be moved, added, or removed the manage columns button 64 can be used. The manage columns button 64 may display a metadata wizard. When columns are added or removed, existing data in the spreadsheet is not changed expect in the case of field deletion. The software plug-in 52 may move data with the associated column.

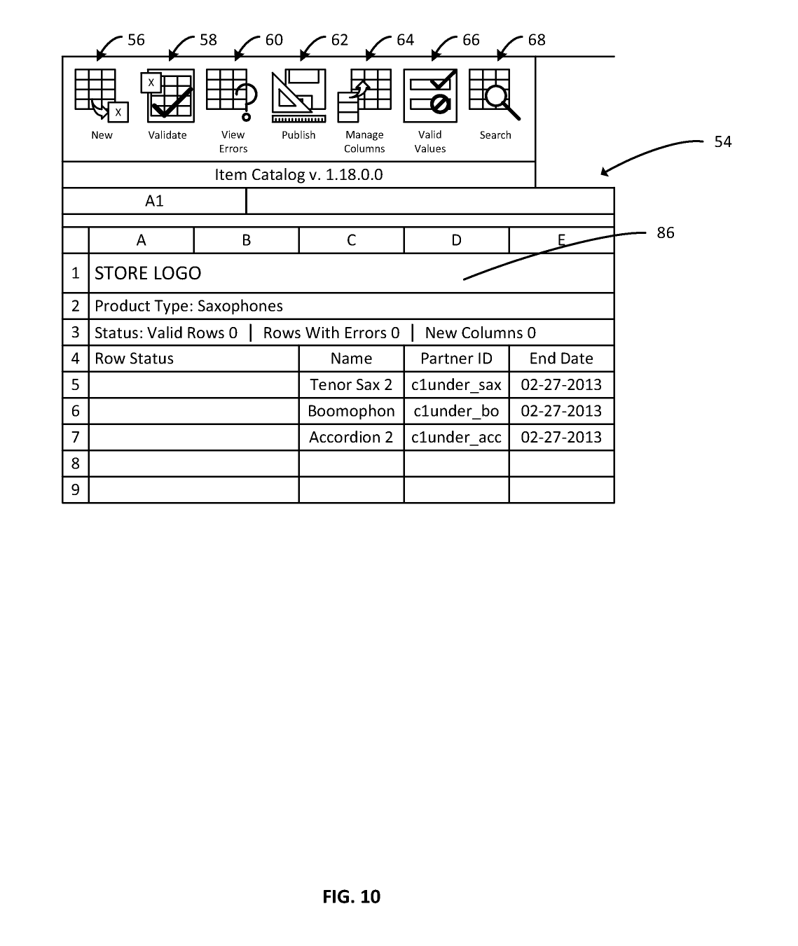

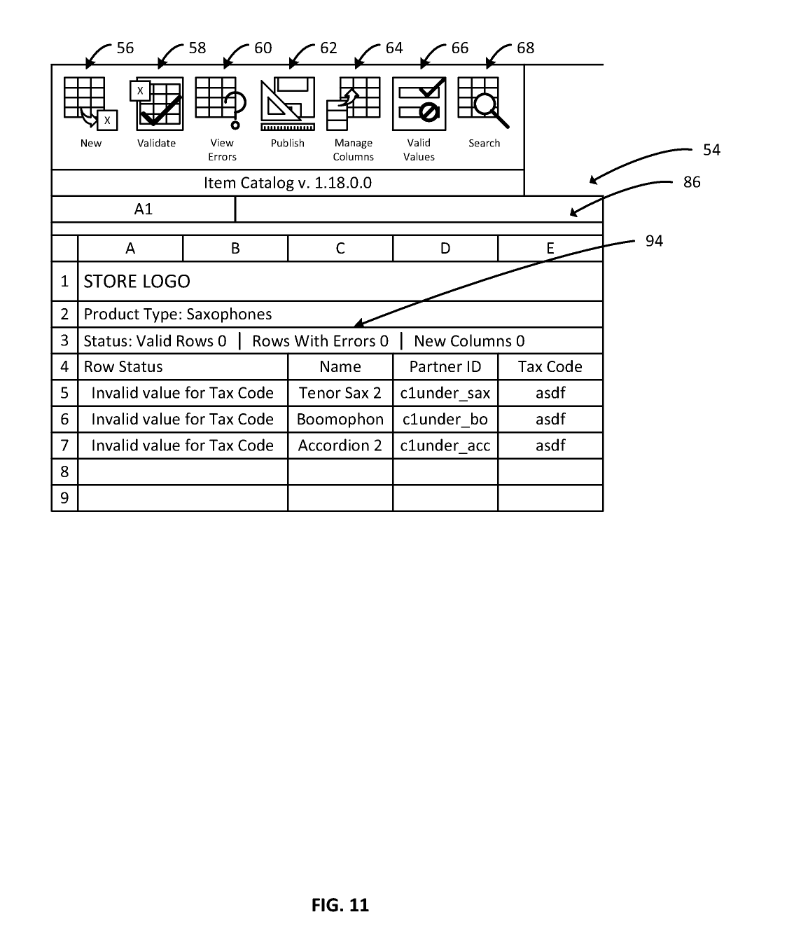

Referring now to FIG. 10, a spreadsheet 58 is shown after a vendor has entered item data into the various columns. Referring now to FIG. 11, the vendor can click the validate button 58 to validate the data which they have entered into the spreadsheet 86. The validate button 58 may cause the software plug-in 52 to preform local validation such as by checking if a date is a valid date. Local validation may be validation as to the form of the data. The software plug-in may provide real time local validation as a vendor enters in data and may indicate to a vendor in real time if an invalid type of data is entered. If the vendor computer 46 is connected to the internet, the validate button 58 may cause the software plug-in to perform server side validations through communication with the item catalog server 34. Server side validation may be used to validate if the content of a value (i.e. data in a data field) is valid, such as by verifying if an entered data value is in a valid values list maintained on the server 34.

The server 34 does not receive the spreadsheet 86, and the vendor does not need to upload anything. The software plug-in 52 communicates with the server 34 to transmit the field data with a field tag or metadata to identify the customer entered data. The item catalog server 34 validates the data and provides information back to the software plug-in 52, indicating any errors that need to be corrected. The software plug-in 52 may modify the spreadsheet to show the vendor what data needs to be fixed. The software lug-in 52 may highlight errors in the data by placing boxes around cells with errors or by changing the background colors of the cells with errors. Additionally, the software plug-in 52 may provide a status header 94 which indicates how many rows (data fields) have errors.

If the customer previously selected an “Unknown Product Type” when initializing the spreadsheet, the server side validation call may determine the product type based on the values provided by the vendor for each data field. If the vendor entered data for different types of products, a new spreadsheet may be created for each product type. Additional required fields for each product type may be automatically added to the end of the spreadsheet by the software plug-in 52. The vendor does not need to now the category of the product. This happens often, as product categories are global and vary store to store. A particular store may have its own product categorization system. It is advantageous for a store to have their own categorization as a global standard may not work will with a store's business practices.

This, however, is difficult for vendors as they will not know where a product fits in the store categories. The software plug-in overcomes this problem as validation with the server can determine the product type from the various data fields which have been entered. The software tells the vendor what it believes the product is and what the product category is based on the data provided by the vendor. The vendor does not have to classify the product as a particular type (router or modem, etc.)

During validation, the software plug-in 52 may automatically create a separate sheet within the spreadsheet for each product type. Where a vendor has entered data for many products into the spreadsheet, validation may cause the software plug-in to create separate sheets for each type of product. This may provide a simpler process and eliminate data errors as each product type will include different mandatory data fields and often include different desired optional data fields.

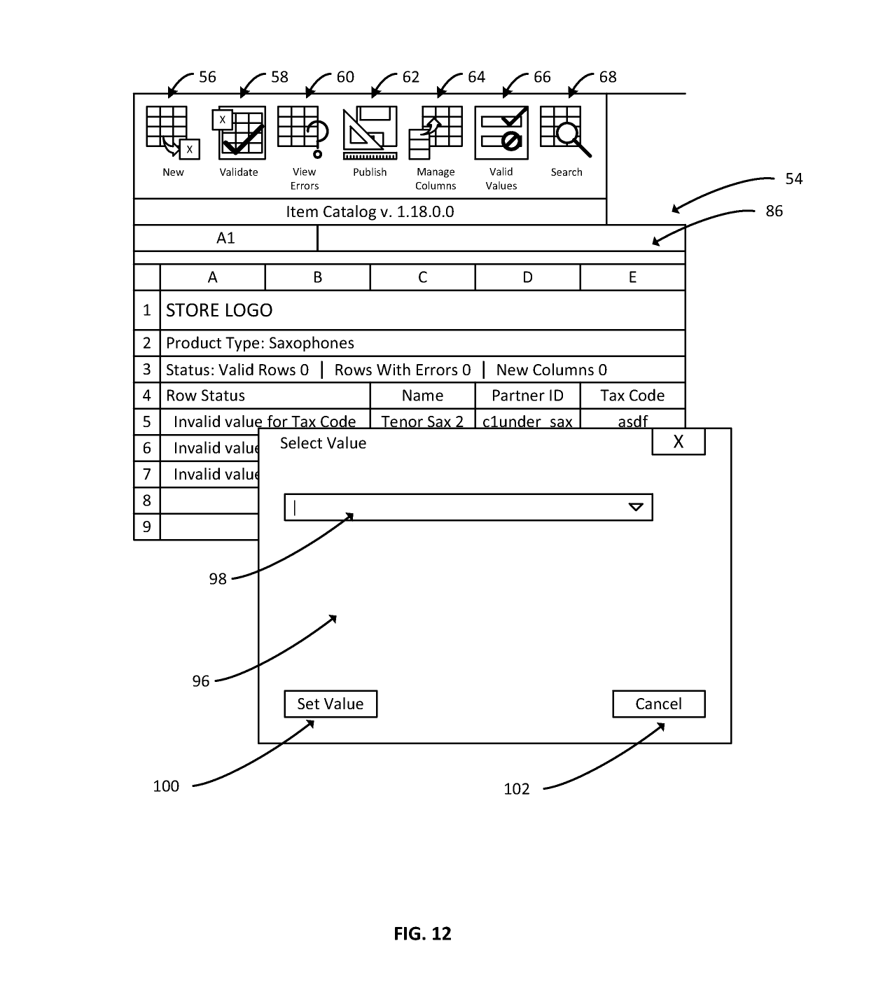

Referring now to FIG. 12, lists of valid values can be displayed by clicking the valid values button 66. Any field that needs a valid value from a list of values has a tooltip to indicate that not just any value will be accepted. This functionality is context specific and will show valid values based on the selected cell in the spreadsheet. In order to resolve any errors in entered data, the vendor may click on a cell with an error and then click on the valid values button 66. The software plug-in 52 may then open a window 96 which displays valid values for the selected data cell. The window 96 may include a drop down menu 98 which the vendor may use to select a value for the cell. If a valid value is found, the vendor may click a button 100 or otherwise enter a command to accept the selected value. If an acceptable value is not found in the drop down list or the vendor is unsure of the appropriate data value, they may select a cancel button 102 to close the window 96.

Some data fields such as states, dimensions, weight, etc. can only have a few valid values. In some cases (such as which states the item may be sold in) the item catalog server 34 can give the valid values to the vendor and the vendor can simply accept the valid values. The vendor may not need to track this information. The item catalog server 34 can provide these values to the user based on the selected product type. There is little chance of error as the item catalog server contains the up to date valid values and these are automatically provided to a vendor as they enter information for a selected item.

The customized spreadsheet as well as additional information such as valid values for data fields is pushed down from the item catalog server to the vendor. Since the spreadsheet is pushed down to the user during creation, validation, etc. the user will always have up to date information to work with. Similarly, for valid values (limited information fields) the server will push down the valid value or the acceptable range of valid values and the user cannot select a value which is not valid. The user does not need to worry about having the up to date value for this field. The user does not need to store spreadsheet templates, etc. Instead, the software plug-in 52 creates a custom spreadsheet for the user according to the product needs.

The software plug-in 52 typically does not publish or store the item data on the item catalog server 34 or in an electronic item catalog when the vendor presses the validate button 66. Validation causes the software plug-in 52 to communicate with the item catalog server 34 and may obtain information from the server 34, such as obtaining valid values corresponding to a particular item and a particular data field/type. The data is validated in real time by the item catalog server 34 and the validation errors show the vendor what data fields need to be corrected.

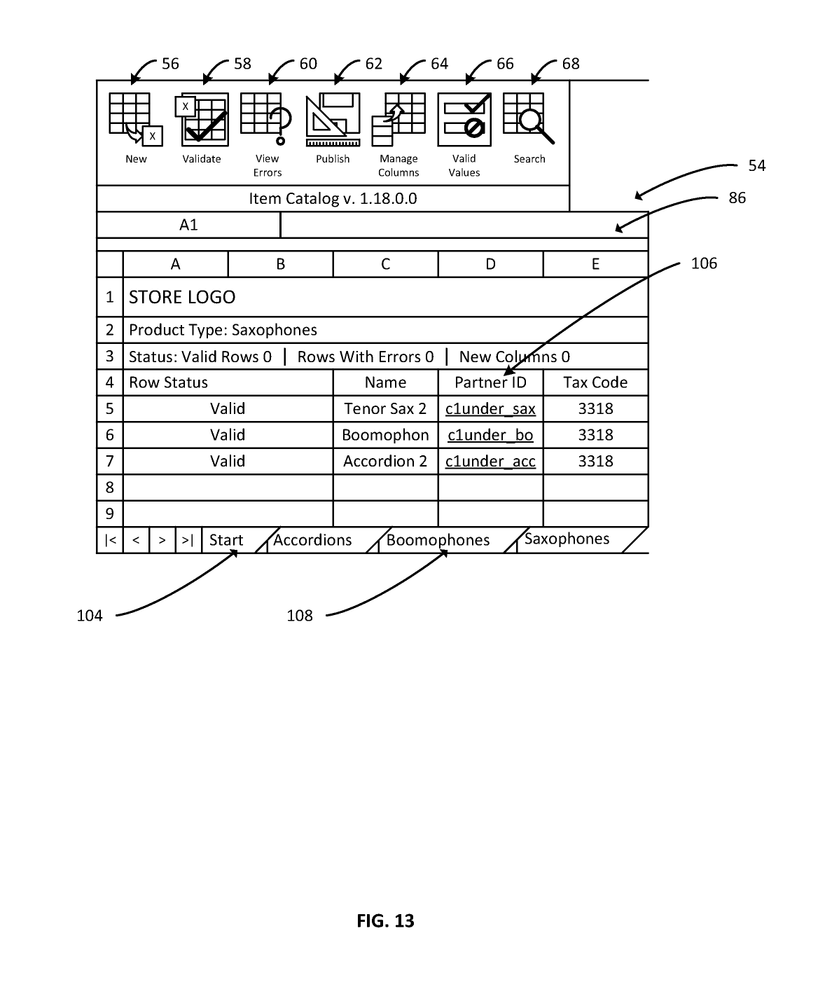

Referring now to FIG. 13, the vendor may correct validation errors and then may click the validate button 66 again to send the item data to the server 34 for product type extraction. The various different items entered by the vendor may then be moved into in a new sheet within the spreadsheet for each product type detected by the server 34. A sheet such as the start sheet 104 may display all entered items while other sheets display only a certain type of item. Values in the “Partner Item ID” column 106 may be made into hyperlinks such that clicking a value in the “Partner Item ID” field will display the sheet containing that product. Any additional product type specific fields have been added to the newly created sheets indicated at 108. Clicking on one of the newly created sheets 108 may display a sheet containing only a single type of item.

Once the item data for each item has been entered into the spreadsheet, the vendor may click on the publish button 62 in order to publish the information in the electronic item catalog. When item data is published, the software plug-in may transmit the item information from the spreadsheet to the item catalog server 34. The item catalog server 34 may then include the item information in the electronic item catalog. If desired, approval of the item information may be required before placing the item information into the electronic catalog. In publishing the item data, the vendor does not need to export or upload any data or otherwise submit any files to the server 34. The software plug-in 52 transmits all necessary information to the server 34 without additional input from the vendor.

The item catalog server 34 does not receive the spreadsheet 86. The software plug-in 52 extracts and transmits the data from the spreadsheet to the server 34, such as by transmitting the data values along with the data type to provide the relevant information to the server. Thus, the item catalog server 34 may only receive the entered data with the field information. Where the software plug-in 52 transmits only the item data to the item catalog server 34, it does not matter how the vendor organizes the spreadsheet 86. The vendor may organize the various columns of data fields in any order and may also enter the item types and various items in any order in the spreadsheet. As the vendor can organize the spreadsheet data field columns in any suitable arrangement, the vendor can simply paste a block of data for a single product or a group of products into the custom created spreadsheet and then validate the data.

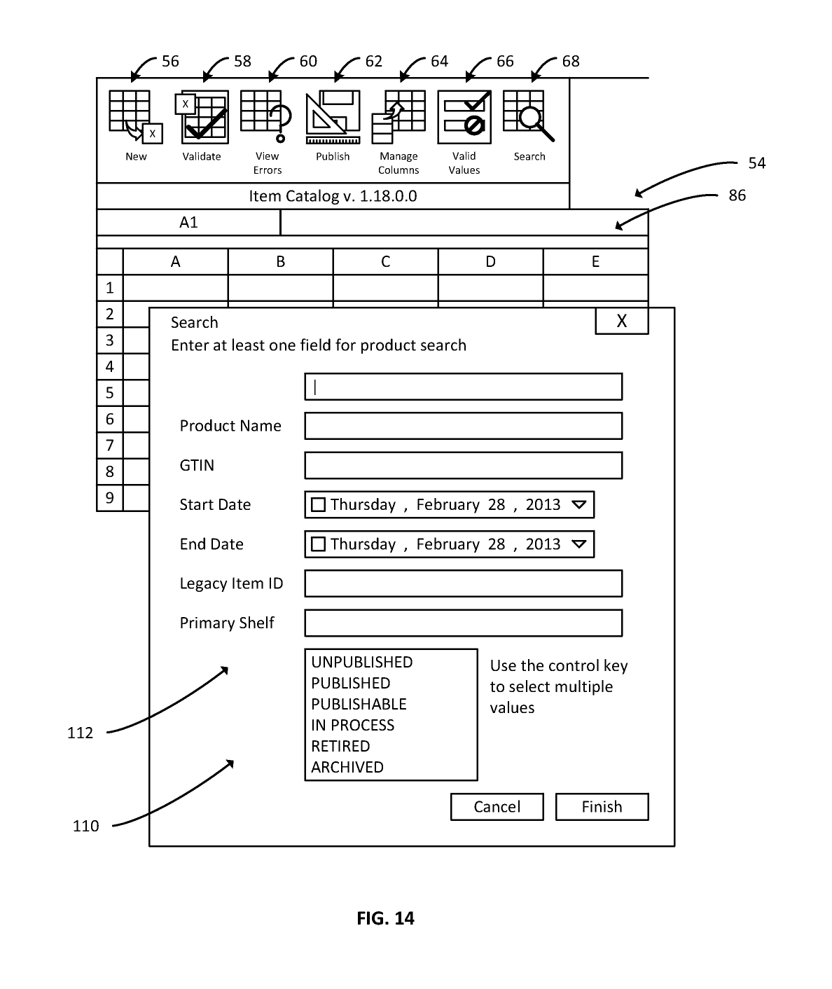

Referring now to FIG. 14, the vendor may click the search button 68 to display a search dialog. This may cause the software plug-in 52 to display a search window 110 which includes various different search fields 112 to allow the vendor to enter search information as well as to specify the limits of the search. Once the desired search terms have been entered, the software plug-in 52 sends the search request to the item catalog server 34. The server 34 sends results back to the software plug-in 52 and the results may be displayed in a new spreadsheet for each type of product returned from the search request. The server 34 may transmit item information to the software plug-in 52. The item information is similar to the item information entered by the vendor (although pertaining to a different item in the electronic catalog) and is similarly displayed in a spreadsheet. The vendor may add additional fields to this item information after the search result has been returned by clicking the manage columns button 64.

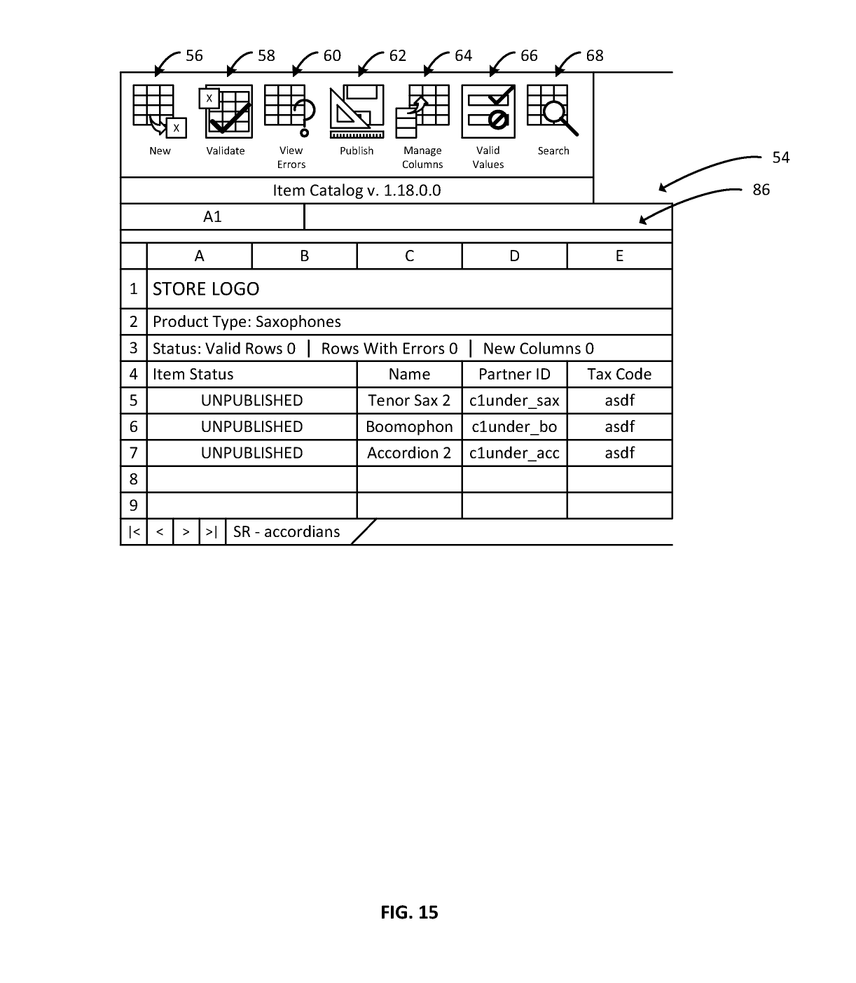

Referring now to FIG. 15, a spreadsheet showing item information retrieved by using the search button 68 is shown. The vendor may use the searched item information as a reference to compare item data values for similar items in the electronic catalog. Additionally, the vendor may use the search button 68 to retrieve and update or modify item information already in the electronic item catalog. In this example, the vendor may only have access to items which they (or their company) have added to the electronic item catalog. The credentials used to authenticate the vendor with the item catalog server 34 may associate the vendor with an account created on the item catalog server 34 and only provide access to those items which have been added to the item catalog server 34 from that account. After retrieving item information from the search feature, the vendor may modify the item information such as by updating the data associated with different data fields. The vendor may then click the publish button 62 to send the modified item information to the item catalog server 34 and publish the updated information in the electronic item catalog.

The vendor may save data which is present in the spreadsheet 86. If the vendor decides to save the spreadsheet of item data, the spreadsheet is saved in a conventional spreadsheet format locally on the vendor's computer 46. The vendor may take the data from an existing spreadsheet and paste it into a new spreadsheet. The vendor may search for data on the item catalog server and save the data locally as a spreadsheet on the vendor computer 46. The vendor can archive a completed spreadsheet and complete work from an earlier saved spreadsheet. The vendor can select and copy/paste information to a new spreadsheet to populate data fields easily for the same type of product. The software plug-in 52 validates data from saved spreadsheets against the item catalog server as additional work is done with these spreadsheets. The vendor can reopen the spreadsheet and continue working and no functionality is lost. The software plug-in 52 takes care of all workflow processes with the spreadsheet and the item catalog server 34 manages all published item data as well as data limitations, valid values, optional/mandatory data fields, etc.

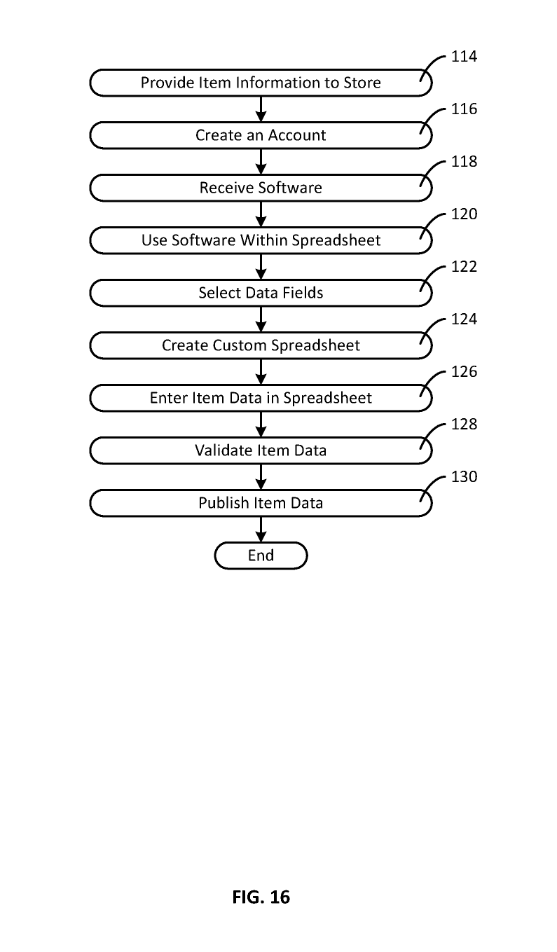

FIG. 16 generally illustrates providing item information to an item catalog server 34. A vendor may decide to provide item information 114 to a store. This may often occur in the process of providing items to the store for sale at a brick and mortar store location or internet store website or in selling items through a store internet marketplace. The vendor may create an account 116 with the store and may receive credentials to allow the vendor to interact with a store item catalog server 34. The vendor may receive 118 software such as a software plug-in 52 from the item catalog server 34 and may thereafter install the software plug-in 52 on a computer 46.

The vendor may use 120 the software plug-in, such as by using a spreadsheet program within which the software plug-in operates. The vendor may select 122 among mandatory data fields and optional data fields to select data fields which are relevant to an item. The software plug-in 52 may thereafter create 124 a custom spreadsheet which contains the data fields selected by the vendor as columns of the spreadsheet. The vendor may then enter 126 data into the spreadsheet cells corresponding to the data fields for the item. The software plug-in may validate 128 the data provided by the vendor. In validating the data, the software plug-in 52 may communicate with the item catalog server 34 and may validate both the form and the content of the data. When the data is validated and any errors have been corrected, the software plug-in 52 may publish 130 the item data by transmitting the data to the item catalog server 34.

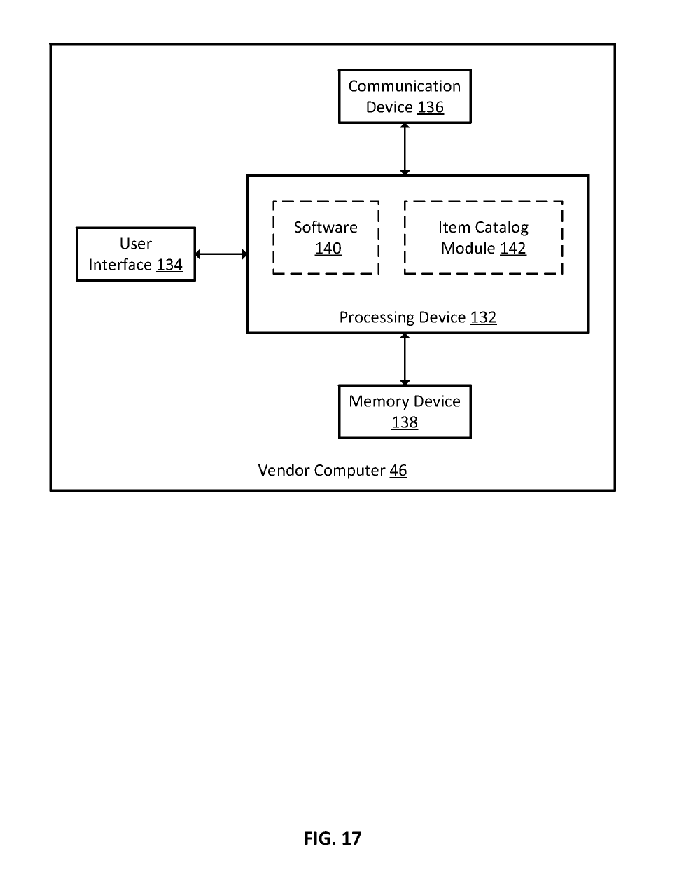

Referring now to FIG. 17, a schematic illustrating example components of the vendor computer 46 is illustrated. In the illustrative embodiment, the computer 46 includes a processing device 132, a user interface 134, a communication device 136, and a memory device 138. It is noted that the computer 46 can include other components and some of the components are not required.

The processing device 132 can include memory, e.g., read only memory (ROM) and random access memory (RAM), storing processor-executable instructions and one or more processors that execute the processor-executable instructions. In embodiments where the processing device 132 includes two or more processors, the processors can operate in a parallel or distributed manner. The processing device 132 can execute the operating system of the computer 46. In the illustrative example, the processing device 132 also executes a software module 140 such as spreadsheet software and an item catalog module 142.

The user interface 134 is a device that allows a user, a vendor in particular, to interact with the computer 46. While one user interface 102 is shown, the term “user interface” can include, but is not limited to, a touch screen, a physical keyboard, a mouse, a microphone, and/or a speaker. The communication device 136 is a device that allows the computer 46 to communicate with another device, e.g., the server 34. The communication device 136 can include one or more wireless transceivers for performing wireless communication and/or one or more communication ports for performing wired communication. The memory device 138 is a device that stores data generated or received by the computer 46. The memory device 138 can include, but is not limited to, a hard disc drive, an optical disc drive, and/or a flash memory drive. The software plug-in 52 may be stored on the memory device 138 and the item catalog module 142 nay be created from the software plug-in 152.

The item catalog module 142 allows a user, a vendor in particular, to process and enter item information to thereby transmit validated item information to the item catalog server 34 as described. The vendor may thus incorporate the item into an electronic item catalog and make the item available for sale through the store.

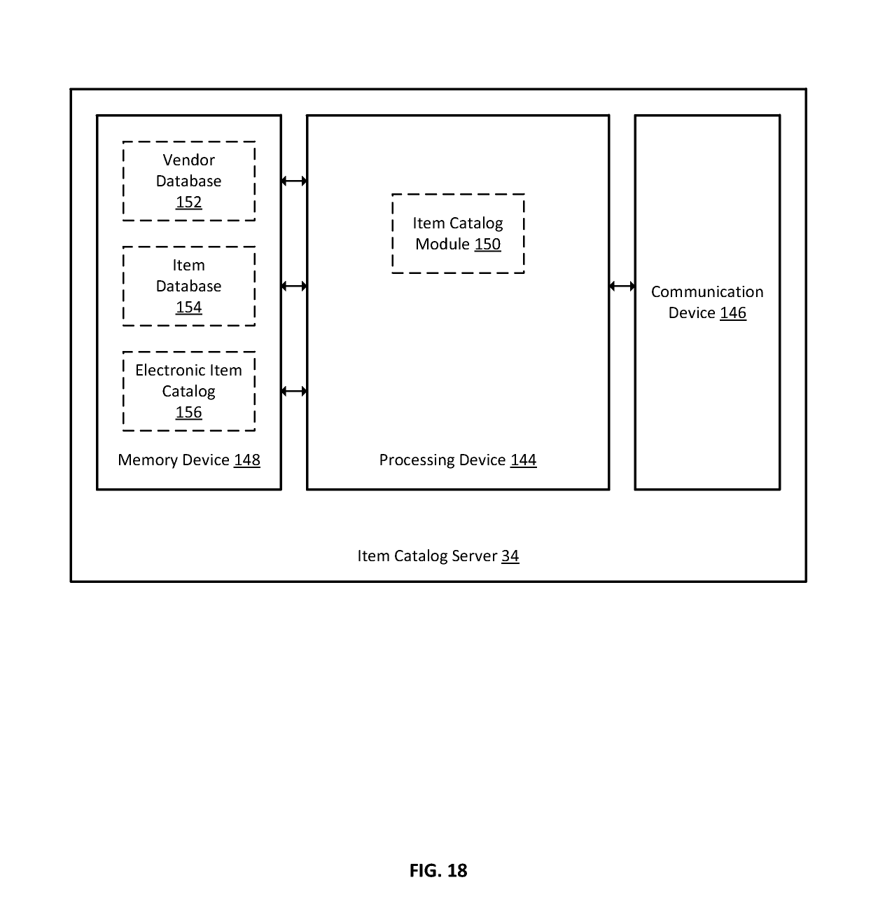

As referenced above, the server 34 may be configured to perform one or more functions at the request of the computer 46 and, according to various computing models, may execute some or all of the functions associated with processing and receiving item data into the electronic item catalog. FIG. 18 illustrates an example embodiment of the item catalog server 34 configured to perform one or more of the requested functions. In the illustrated embodiment, the server 34 may include a processing device 144, a communication device 146, and a memory device 148.

The processing device 144 can include memory, e.g., read only memory (ROM) and random access memory (RAM), storing processor-executable instructions and one or more processors that execute the processor-executable instructions. In embodiments where the processing device 144 includes two or more processors, the processors can operate in a parallel or distributed manner. In the illustrative embodiment, the processing device 144 executes an item catalog module 150.

The communication device 146 is a device that allows the server 34 to communicate with another device, e.g., the computer 46. The communication device 146 can include one or more wireless transceivers for performing wireless communication and/or one or more communication ports for performing wired communication.

The memory device 148 is a device that stores data generated or received by the server 34. The memory device 148 can include, but is not limited to a hard disc drive, an optical disc drive, and/or a flash memory drive. Further, the memory device 148 may be distributed and located at multiple locations. The memory device 148 is accessible to the processing device 144. In some embodiments, the memory device 148 stores a vendor database 152, an item database 154, and an electronic item catalog 156.

In some embodiments, the vendor database 152 can store information associated with a vendor. The vendor database may, for example, store information associated with a vendor account and may include account preferences and vendor contact information. The vendor database may also store information regarding particular items in the electronic item catalog which are associated with a particular vendor. The vendor database may be queried by the processing device 144 and may provide information to the processing device to facilitate identifying vendor and to facilitate identifying items associated with vendor.

In some embodiments, the item database 154 stores item information associated with items or types of items. For example, the item database 154 may store the data fields and valid values associated with the items. By way of example, the item database 154 may be queried by the processing device 144 and may transmit information to the processing device to facilitate the use of item data.

In some embodiments, the electronic item catalog 156 stores item information associated with the sale of items through the store or associated websites. For example, the electronic item catalog 156 may store the data associated with various data fields. By way of example, the electronic item catalog 156 may be queried by the processing device 144 and may transmit information to the processing device to facilitate the use of item data, such as in adding items to the electronic item catalog, updating items in the electronic item catalog, and in selling items at a brick and mortar store or a webpage.

The processing device 144 may execute the item catalog module 150. The item catalog module 150 may receive item information, validate item information, provide item information such as item types, etc. The item catalog module 150 may facilitate the entry of item information into computer 46 for receipt of the item information into the electronic item catalog.

The examples discussed provide significant advantages. Conventional item setup for sale takes weeks to months and involves multiple handoff points with specified data expected at every point. The examples speed up the process to incorporate new products and make it easier for both the vendor and the store. Products are available quicker for sale and customers are not lost during the initial period of a new product.

Providing item data is streamlined so that only necessary attributes are asked for. The software plug-in only requires what the store needs at that time. When a vendor enters a product, the software plug-in tells the vendor what data is needed for the particular product type. The data fields are different for different types of products. The software plug-in guides the vendor through the process and tells the vendor what is wrong and what needs to be fixed. When the vendor chooses a product type, the spreadsheet add in tells them what types of data are necessary and modifies the spreadsheet to have the appropriate data fields.

The vendor does not have to enter data into a downloaded generic sheet and upload it. The software plug-in creates the spreadsheet for the vendor, with data fields and a modified spreadsheet customized to a particular product. The vendor enters data into the spreadsheet and submits the data. The spreadsheet is validated electronically in real time when a vendor enters data and when the vendor submits it and the server can tell the vendor if information is incorrect or missing.

A vendor is given options for what data they want to enter. Some are required (bold columns/data). The columns are customizable by the vendor. They can see only required fields for data, and can also see additional optional fields to provide additional data for the product. The server can receive and process the spreadsheet to integrate the product and can incorporate whatever additional (non-required) data is provided by the vendor.

The columns may be locked sufficiently to eliminate errors in submitting data to the server 34. The vendor cannot add random columns, but can select from many available columns for desired (optional) data. The software has structure and requirements (primarily requiring the vendor to correctly enter data into required fields (columns) on the spreadsheet) which ensure that the necessary product data is acquired for publishing to the website (or incorporation into the store inventory and sales systems). Additionally, the software has flexibility to allow the vendor to add additional non desired data fields to provided desired additional product data.

The software plug-in gets to the details of particular products. When a vendor selects a product type, the software plug-in customizes the data fields for that product to show what data is necessary for that particular product. There is not a generic spreadsheet which is downloaded for an entire store or entire division (i.e. electronics). The spreadsheet is created according to user selection and data fields (columns) are created in the spreadsheet according to user selection of product type so that the spreadsheet is customized for the user's needs.

The vendor does not have to send or manually upload anything to the server. The vendor simply presses a button in the spreadsheet software created by the software plug-in and the spreadsheet software sends data directly to the server and does not send the spreadsheet. There is no server extraction or analysis of a spreadsheet. The spreadsheet is not sent to the server and data comes straight into the server with a data tag or metadata, etc. as provided by the software plug-in. As a result, data fields (spreadsheet columns) are submitted to the server with appropriate metadata or data tags to identify the type of information and allow the server to integrate the product into the website or sales system. The server may automatically organize the data entered for a product into a product listing, product display, webpage display, shelf tag or inventory listing, etc. Most product data entry will be valid and ready to be published on a sales website of used for in store sales without further information.

As the software plug-in utilizes a known spreadsheet program, there is no new software or application to learn. A software plug-in is well suited for power users who know how to quickly handle necessary input, formatting, calculations etc. due to familiarity with spreadsheets. The software plug-in may handle one item or thousands of items. All small and medium vendors may use it. The software plug-in gives vendors individual item attention while allowing them to upload information for many items together. The tool highlights individual items from a large group that need addition information or corrections and highlights what data fields on that items need correction. Vendors can submit hundreds of items and the tool will highlight a few particular items which need correction and allow correction and resubmission of those items.

The above description of illustrated examples of the present invention, including what is described in the Abstract, are not intended to be exhaustive or to be limitation to the precise forms disclosed. While specific embodiments of, and examples for, the invention are described herein for illustrative purposes, various equivalent modifications are possible without departing from the broader spirit and scope of the present invention. Indeed, it is appreciated that the specific example voltages, currents, frequencies, power range values, times, etc., are provided for explanation purposes and that other values may also be employed in other embodiments and examples in accordance with the teachings of the present invention.

1. A computer implemented method comprising:
supporting, by a retailer, a computer system and a software plug-in;
expanding, by the software plug-in, capabilities of a spreadsheet software corresponding to a vendor;
receiving, by the computer system from the software plug-in, first item information input by the vendor into the spreadsheet software, the first item information relating to an item which is to be included in an electronic item catalog for sale through a store of the retailer;
providing by the computer first item information, a customized spreadsheet to the spreadsheet software, wherein the customized spreadsheet is customized for the item based on the first item information;
receiving, by the computer system via the software plug-in, second item information input into the customized spreadsheet by the vendor;
validating, by the computer system, the second item information; and
publishing, by the computer system, the second item information to the electronic item catalog.

2. The method of claim 1, wherein the step of publishing the second item information more specifically comprises receiving the second item information without receiving the customized spreadsheet into the computer system.

3. The method of claim 1, wherein the step of receiving first item information more specifically comprises receiving a selection of an item type from the vendor, and wherein the step of providing a customized spreadsheet more specifically comprises providing a customized spreadsheet which identifies necessary item information for the item based on the item type.

4. The method of claim 1, wherein:
the step of receiving first item information more specifically comprises receiving a selection of an item type from the vendor;
wherein the method further comprises:
providing optional data fields specifically related to the item to the vendor based on the received item type;
receiving a selection of one or more optional data fields from the vendor; and
wherein the step of providing a customized spreadsheet more specifically comprises providing a customized spreadsheet which includes the one or more optional data fields.

5. The method of claim 1, wherein the method further comprises receiving an indication of an unknown item type for the item, wherein the first item information describes properties about the item, and wherein the step of providing a customized spreadsheet to spreadsheet software comprises providing an item type to the vendor based on the first item information received from the vendor.

6. The method of claim 1, wherein the method further comprises receiving an indication of an unknown item type for the item, wherein the first item information describes properties about the item, and wherein the step of providing a customized spreadsheet to spreadsheet software more specifically comprises indicating additional required item data fields to the vendor based on the first item information received from the vendor.

7. The method of claim 1, wherein the method further comprises:
providing the software plug-in to the vendor; and
the software plug-in communicating remotely with the computer system to validate data in real time as the vendor enters data into the customized spreadsheet.

8. The method of claim 7, wherein the method further comprises the computer system transmitting data to the software plug-in to provide a list of valid data values which are specific to a data field associated with the item.

9. (canceled)

10. The method of claim 1, wherein the method further comprises:
providing the software plug-in to the vendor;
the software plug-in extracting data values and data field information from the customized spreadsheet; and
the software plug-in transmitting the data values and data field information to the computer system without transmitting the customized spreadsheet to the computer system.

11. A computer system comprising:
a software plug-in expanding the capabilities of spreadsheet software corresponding to a Vendor;
at least one processor;
memory operably connected to the at least one processor; and
the memory storing an item catalog module programmed to:
receive, from the software plug-in, first item information input by the vendor into the spreadsheet software, the first item information relating to an item which is to be included in an electronic item catalog for sale through a store;
provide, via the software plug-in after the receipt of the first item information, a customized spreadsheet to the spreadsheet software, wherein the customized spreadsheet is customized for the item according to the first item information;
receive, via the software plug-in, second item information input into the customized spreadsheet by the vendor;
validate the second item information; and
publish the second item information to an item catalog server for inclusion in the electronic item catalog.

12. The computer system of claim 11, wherein the item catalog module is more specifically programmed to:
receive the second item information into the item catalog server without receiving the customized spreadsheet into the item catalog server.

13. The computer system of claim 11, wherein the item catalog module is more specifically programmed to:
receive, as part of the first item information, a selection of an item type from the vendor; and
provide the customized spreadsheet with the customized spreadsheet identifying necessary item information for the item based on the item type.

14. The computer system of claim 11, wherein the item catalog module is more specifically programmed to:
receive, as part of the first item information, a selection of an item type from the vendor;
provide optional data fields specifically related to the item to the vendor based on the received item type;
receive a selection of one or more optional data fields from the vendor; and
provide the customized spreadsheet with the customized spreadsheet including the one or more optional data fields.

15. The computer system of claim 11, wherein the item catalog module is programmed to:
receive, as part of the first item information, an indication of an unknown item type for the item;
wherein the first item information describes properties about the item; and
wherein the item catalog module is more specifically programmed to:
provide an item type to the vendor based on the first item information received from the vendor.

16. The computer system of claim 11, wherein the item catalog module is programmed to:
receive, as part of the first item information, an indication of an unknown item type for the item;
wherein the first item information describes properties about the item; and
wherein the item catalog module is more specifically programmed to:
indicate additional required item data fields to the vendor based on the first item information received from the vendor.

17. The computer system of claim 11, wherein the item catalog module is programmed to:
communicate remotely with the item catalog server to validate data in real time as the vendor enters data into the customized spreadsheet.

18. The computer system of claim 17, wherein the item catalog server is programmed to transmit data to the vendor to provide a list of valid data values which are specific to a data field associated with the item.

19. The computer system of claim 11, wherein the item catalog module is programmed to:
extract data values and data field information from the customized spreadsheet; and
transmit the data values and data field information to the item catalog server without transmitting the customized spreadsheet to the item catalog server.

20. A computer program product embodied in a non-transitory computer readable storage medium comprising computer instructions for:
receiving, from a software plug-in expanding the capabilities of spreadsheet software corresponding to a vendor, first item information input by the vendor into the spreadsheet software, the first item information relating to an item which is to be included in an electronic item catalog for sale through a store;
providing, via the software plug-in after the receipt of the first item information a customized spreadsheet to the spreadsheet software, wherein the customized spreadsheet is customized for the item based on the first item information;
receiving second item information input into the customized spreadsheet by the vendor;
validating the second item information; and
publishing the second item information to an item catalog server for inclusion in the electronic item catalog.
